(19) United States
(12) Patent Application Publication
(10) Pub. No.: US 2026/0147890 A1
(43) Pub. Date: May 28, 2026

(54) INLINE MALICIOUS XML DETECTION WITH COMBINED HEURISTIC ANALYSIS AND DEEP LEARNING

(71) Applicant: Palo Alto Networks, Inc., Santa Clara, CA (US)

(72) Inventors: Yiheng An, San Jose, CA (US); Haozhe Zhang, San Jose, CA (US); Zhibin Zhang, Santa Clara, CA (US); Qi Deng, Sunnyvale, CA (US)

(21) Appl. No.: 19/041,041

(22) Filed: Jan. 30, 2025

Related U.S. Application Data
(60) Provisional application No. 63/724,141, filed on Nov. 22, 2024.

(51) Int. Cl. G06F 21/56

(52) U.S. Cl. CPC G06F 21/565; G06F 2221/034

(57) ABSTRACT

A traffic filter executing as part of a cybersecurity appliance detects network traffic that includes XML files. The traffic filter forwards the XML file identified in the network traffic to a malicious XML detector for further analysis. The detector heuristically analyzes the XML header and analyzes the XML document with a combination of heuristic analysis and deep learning. The detector analyzes the XML header with heuristics-based rules. The detector also analyzes the XML document using additional heuristics-based rules and/or with a model trained to predict whether XML documents are malicious. If the results of the analyses yields a verdict that the XML document is malicious, the detector returns a verdict indicating that the XML file is malicious to the traffic filter for the malicious XML file to be blocked accordingly.

### BACKGROUND

The disclosure generally relates to security arrangements for protecting computers, components thereof, programs or data against unauthorized activity (e.g., CPC subclass G06F 21/00) and to network architectures or network communication protocols for network security (e.g., CPC subclass H04L 63/00).

Extensible Markup Language (XML) files are plain text files structured to store and transport data in a readable, hierarchical format. XML uses custom, user-defined tags to organize information. The data are typically organized as elements enclosed by tags, with attributes optionally providing additional metadata. XML files can be used to carry out attacks, often by targeting systems or applications that process XML files. For instance, XML files can comprise malicious code, including code that exploits vulnerabilities. Examples of attacks that may be carried out via XML include XML External Entity (XXE) attacks, XML or XPath injection, and denial-of-service (DoS) attacks.

Tree-LSTM (long short-term memory) models are an extension of the standard LSTM neural network architecture and are designed to process data structured in tree-like, rather than linear, formats. Tree-LSTMs were introduced to handle hierarchical or non-sequential data, such as syntactic parse trees in natural language processing (NLP) or hierarchical representations in knowledge graphs.

### BRIEF DESCRIPTION OF THE DRAWINGS

Embodiments of the disclosure may be better understood by referencing the accompanying drawings.

FIG. 1 is a conceptual diagram of filtering network traffic detected by a firewall to designate for inline malicious XML detection.

FIG. 2 is a conceptual diagram of inline detection of malicious XML files using combined heuristic and deep learning techniques.

FIG. 3 is a flowchart of example operations for inline detection of malicious XML files identified in network traffic.

FIG. 4 is a flowchart of example operations for evaluating an XML header for maliciousness based on heuristic-based rules.

FIG. 5 is a flowchart of example operations for evaluating an XML document for maliciousness based on heuristics-based rules and/or classification by a trained model.

FIG. 6 is a flowchart of example operations for determining if an XML document is malicious based on classification by a trained model.

FIG. 7 is a flowchart of example operations for performing inline detection of malicious XML files.

FIG. 8 depicts an example computer system with a traffic filter and a malicious XML detector.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Overview

A system has been designed for inline detection of malicious XML files transmitted in network traffic that comprises a traffic filter executing on a cybersecurity appliance (e.g., a firewall) and a malicious XML detector (“detector”), which may execute in the cloud. The traffic filter is configured with one or more rules for detecting network traffic that potentially includes malicious XML files, such as a pattern(s) for detecting XML files in network traffic. If network traffic detected by the cybersecurity appliance satisfies a rule of the traffic filter, the traffic filter forwards the XML file identified in the network traffic to the detector for further analysis. The traffic filter thus filters out network traffic potentially including malicious XML files and designates the XML files for further analysis.

Malicious XML detection is performed using a combination of heuristic analysis and deep learning. The detector splits detected XML files forwarded from the traffic filter into its header (if any) and document components and analyzes each separately for maliciousness, as XML headers and documents can comprise different malicious indicators. Header analysis leverages heuristics-based rules, such as rules for pattern matching of XML headers to various malicious indicators. The detector also subjects the XML document to analysis using additional heuristics-based rules and/or with a trained model such as a LSTM model or Tree-LSTM model that predicts whether XML documents are malicious based on a vector representation thereof. The vector representation of the XML document indicates hierarchical structure of the XML document to preserve parent-child relationships of nodes of the corresponding XML tree. If any of the analyses results in a verdict that the XML document is malicious, the detector generates a verdict indicating that the XML file is malicious and returns the verdict to the cybersecurity appliance for the traffic to be blocked accordingly.

### Example Illustrations

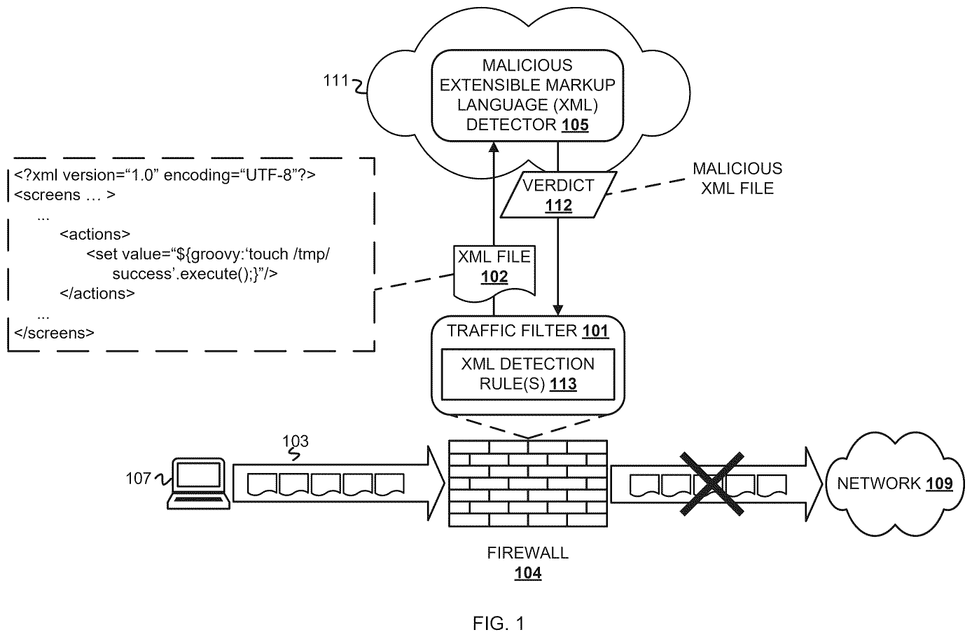

FIG. 1 is a conceptual diagram of filtering network traffic detected by a firewall to designate for inline malicious XML detection. A firewall 104 secures a network 109. The firewall 104 may be a cloud-based firewall, a virtual firewall, or a physical firewall deployed to inspect network traffic sent to and from the network 109. FIG. 1 depicts an endpoint device 107 assumed to be connected to the network 109 and for which the firewall 104 intercepts and inspects inbound and outbound network traffic. FIG. 1 depicts a malicious XML detector (“detector”) 105. The malicious XML detector 105 analyzes detected XML files with a combination of heuristic analysis and machine learning to determine if XML files are likely malicious and/or comprise vulnerabilities. The detector 105 in this example executes in a cloud 111 as a cloud-based service that communicates with the traffic filter 101. In other examples, the detector 105 can execute as a service of the firewall 104. The detector 105 may further be subservices of a collective security service for analyzing network traffic flagged at the firewall 104 for further analysis; in other words, additional detectors/analyzers can execute in the cloud 111 for inspection of network traffic for other security concerns in addition to malicious XML detection.

FIG. 1 also depicts a traffic filter 101 that executes on the firewall 104. The traffic filter 101 identifies network traffic (or data identified therein, such as detected XML files) that should be filtered out and forwarded to the detector 105 for further analysis. The traffic filter 101 has been configured with one or more XML filtering rules (“rule(s)”) 113 that, if satisfied, trigger forwarding of the network traffic that satisfies the rule(s) 113 to the detector 105. The rule(s) 113 comprises one or more rules for identifying network traffic that comprises an XML file that should be analyzed to determine whether the XML file is malicious and thus should be inspected by the detector 105. For instance, the rule(s) 113 can comprise one or more patterns defined for matching traffic that comprises an XML file, such as a pattern for detecting XML headers (sometimes referred to as XML declarations or XML prologs).

Referring to this example, the firewall 104 detects network traffic 103 sent from the endpoint device 107, and the traffic filter 101 evaluates the network traffic 103 based on the rule(s) 113. This example assumes that the network traffic 103 comprises an XML file 102 that matches the rule(s) 113 and thus triggers analysis of the XML file 102 by the detector 105 By default, a copy of the network traffic 103 comprising the XML file 102 can be sent to the detector 105, where it is held until a result indicating whether the XML file 102 is malicious or benign is received (e.g., in a holding mode of the firewall 104). However, in implementations, the firewall 104 can be configured to forward the network traffic 103 to its destination before the result is received (e.g., in implementations where the firewall 104 mirrors network traffic to the detector 105). For instance, the XML file 102 may be included in a Hypertext Transfer Protocol (HTTP) request sent by the endpoint device 107. The contents of the XML file 102 is depicted in further detail as an illustrative example:

```
<?xml version=“1.0” encoding=“UTF-8”?>
<screens ... >
  ...
    <actions>
      <set value=“${groovy:‘touch /tmp/success’.execute( );}”/>
    </actions>
  ...
</screens>
```

In this example, the XML header of the XML file 102 matches the rule(s) 113 and thus triggers forwarding of the XML file 102 to the detector 105.

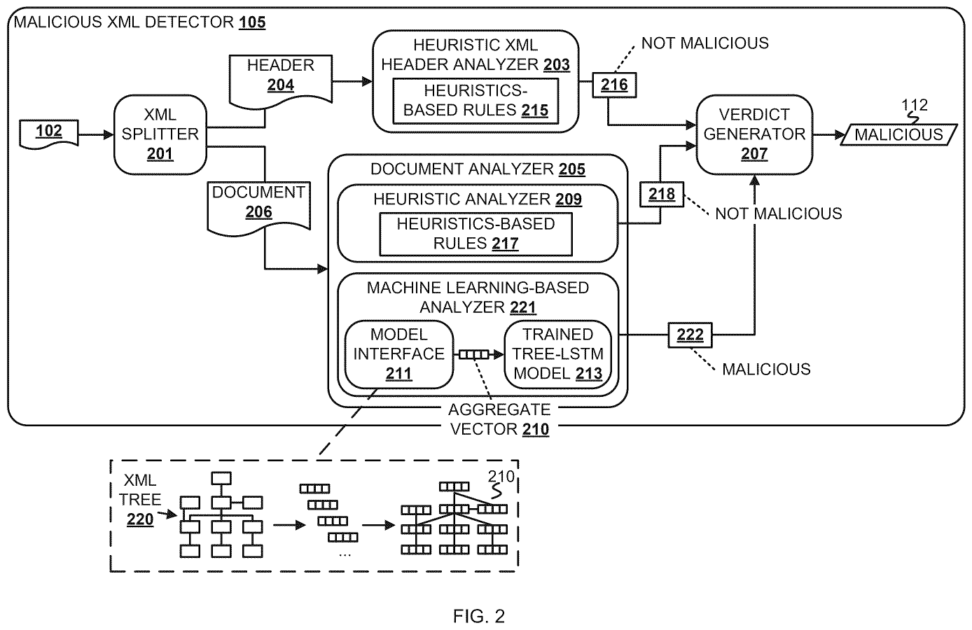

The detector 105 obtains the XML file 102 and determines if the XML file 102 is malicious based on at least one of its header component and document component. XML header analysis is performed based on a plurality of heuristics-based rules. The detector 105 analyzes the document component of the XML file with a combination of heuristic and machine learning approaches. The detector 105 heuristically analyzes the XML document based on additional heuristics-based rules. The detector 105 also generates an embedding representing the XML document and inputs the embedding into a model (e.g., a neural network) trained for predicting whether XML documents are malicious. The detector 105 can perform each of these analyses in parallel and determine a final verdict for the XML file 102 based on results of each individual analysis. Analysis of the XML file 102 by the detector 105 is described in further detail in reference to FIG. 2.

In this example, the detector 105 determines based on analysis of the XML file 102 that the XML file 102 is malicious and generates a verdict 112 indicative of such. The detector 105 communicates the verdict 112 to the traffic filter 101, and the firewall 104 can thus block the network traffic 103 comprising the XML file 102.

FIG. 2 is a conceptual diagram of inline detection of malicious XML files using combined heuristic and deep learning techniques. FIG. 2 depicts the detector 105 of FIG. 1 in further detail. The detector 105 comprises an XML splitter 201 that splits (i.e., parses) the XML file 102 into its two components: an XML header 204 and an XML document 206. The XML document 206 comprises the contents of the XML file 102 separated from its header/declaration. Splitting the XML file 102 can be performed based on matching the XML header to a pattern, such as a regular expression, by which XML headers can be distinguished from the subsequent contents of their files, such as a pattern for detecting the presence of “<? xml” in an XML file.

The XML header 204 and XML document 206 are analyzed by separate respective analyzers of the detector 105. A heuristic XML header analyzer (“header analyzer”) 203 analyzes the XML header 204 with heuristic-based rules 215 for determining whether an XML header is indicative of maliciousness. The heuristic-based rules 215 with which the header analyzer 203 has been configured include rules for detecting malicious XML based on the header schema, a length of the header, the presence of special characters in the header associated with malicious XML. Additionally or alternatively, the heuristics-based rules 215 can include other patterns for identifying other exploits or malicious XML, such as server-side request forgery (SSRF) attacks, DoS attacks, XPath injection, or namespace confusion attacks (e.g., the regular expression <!ENTITY\s+\w+\s+SYSTEM\s+“file:VVV[\hat{ }\s”]+ for detecting XML External Entity (XXE) attacks). If one or more of the heuristic-based rules 215 are satisfied, the header analyzer 203 determines that the XML header 204 is indicative of maliciousness and generates a malicious verdict for the XML file 102. However, this example assumes that the header analyzer 203 determines that the XML header 204 does not satisfy any of the heuristic-based rules and generates a “not malicious” verdict 216 for the XML header 204.

A document analyzer 205 analyzes the XML document 206 with a combination of heuristic and machine-learning based techniques to determine whether the XML document 206 is malicious. The document analyzer 205 comprises a heuristic analyzer 209 for performing the heuristic analysis and a machine-learning based analyzer 221. The machine-learning-based analyzer 221 comprises a model interface 211 and a trained Tree-LSTM model 213, which has been trained to predict whether XML documents represented with vectors provided as input are malicious. The document analyzer 205 can perform the heuristic analysis and machine-learning based analysis in parallel, with the XML document 206 being copied and provided to each of the heuristic analyzer 209 and the machine-learning based analyzer 221 for their respective analyses.

The heuristic analyzer 209 analyzes the XML document 206 with heuristic-based rules 217 for detecting malicious XML documents. The heuristic-based rules 217 comprise rules for determining whether an XML document is likely to be malicious based on its contents, such as based on whether the XML document comprises embedded code, encoded text, or other indications of anomalies or attacks. For instance, these heuristic-based rules 217 can comprise patterns (e.g., regular expressions) for detecting embedded code or encoded text (e.g., the regular expression (exec|assert|chmod|\{)eval)|echo|bash|curl∥wget|awk|grep|touch)[\hat{ }a-z]). Additionally, the heuristic analyzer 209 can evaluate the text of the XML document 206 for the presence of keywords or attribute values that are commonly associated with malicious intent, with these keywords/attribute values indicated in the heuristic-based rules 217. The heuristic analyzer 209 can flag these keywords/attribute values as critical, which can thus contribute to a malicious verdict for the XML document 206. Examples include the attributes and corresponding values “role=admin”, “role=guest” (or other attribute values indicating unauthorized access control manipulation) and the attribute value “getRuntime” (or other attribute values that directly trigger actions that may be suspicious). This example assumes that the heuristic analyzer 209 determines that the XML document 206 is not malicious and generates a verdict 218 indicative of such.

The model interface 211 generates an XML tree 220 representing the XML document 206. The XML tree 220 comprises a plurality of nodes, with each node representing an attribute, element, or text of the XML document 206. The model interface 211 can generate the XML tree 220 using an open-source and/or off-the-shelf tool for XML tree generation. For each node of the XML tree 220, the model interface 211 generates a vector representation thereof. The model interface 211 can generate the vector representation of the node based on a type of the node, such as based on whether the node represents an attribute, element, or text of the XML document 206. For instance, the model interface 211 can leverage a text embedding model such as word2vec or doc2vec for generating vector representations of nodes representing text and/or can generate one-hot encodings for nodes representing attributes and elements. When generating one-hot encodings, each unique tag that defines an element and each unique attribute identified in the XML tree 220 is considered a category represented in the one-hot encodings. To illustrate, the tags <users>, <user>, <name>, and <email> would be represented as separate categories in a one-hot vector, as would the attributes “id” and “role.” Some lesser-used or custom tags and/or attributes may be grouped collectively into an “other” category for one-hot encoding purposes to reduce sparsity. The model interface 211 may thus determine which tag names and attribute names in the XML tree 220, if any, have an occurrence below a threshold (e.g., those that have a single occurrence) and group these tag names and/or attributes into the “other” category for their representation in the one-hot encoding. Any keywords/attribute values flagged as critical during the heuristic analysis as described above are also identified in the XML tree 220 and thus represented in the one-hot vector.

The model interface 211 generates an aggregate vector 210 from the XML document 206 based on aggregating the plurality of vector representations of the XML tree 220. Aggregation techniques can vary depending on the type of trained model employed for malicious XML detection. In this example, since a trained Tree-LSTM model is being utilized, the model interface 211 aggregates the plurality of vector representations such that the parent-child representations of the XML tree 220 are maintained and the aggregate vector 210 comprises a tree structure compatible with input to the trained Tree-LSTM model 213. The model interface 211 passes the aggregate vector 210 to the trained Tree-LSTM model 213 for classification. This example assumes that the Tree-LSTM model 213 outputs a prediction that the XML document 206 is malicious based on its features captured in the aggregate vector 210. The machine-learning-based analyzer 221 thus generates a verdict 222 that the XML document 206 is malicious. The verdict 222 may also indicate a confidence associated with the malicious prediction output by the trained Tree-LSTM model 213.

A verdict generator 207 determines the verdict 112 for the XML file 102 based on the verdicts 216, 218, 222 output by the header analyzer 203, the heuristic analyzer 209, and the machine learning-based analyzer 221 for the respective components of the XML file 102. The verdict generator 207 can generate a malicious verdict based on whether at least one of the header analyzer 203, the heuristic analyzer 209, and the machine learning-based analyzer 221 generated a malicious verdict. Since the verdict 222 in this example is a malicious verdict, which may be further determined to have sufficient confidence (e.g., satisfying a threshold) output by the trained Tree-LSTM model 213, the verdict generator 207 generates the verdict 112 indicating that the XML file 102 is malicious.

While FIG. 2 depicts a trained Tree-LSTM model being used for XML document classification, other models can be employed in implementations, such as LSTM models or other neural networks. In these cases, when generating the vectors from the XML tree of an XML document, the model interface 211 can indicate the level of each node in the hierarchy of the XML tree (e.g., depth) in the corresponding vector representation of the node. Examples of hierarchical level indications are raw numerical values and vector representations of labels or numerical values appended to the vector representation of the node.

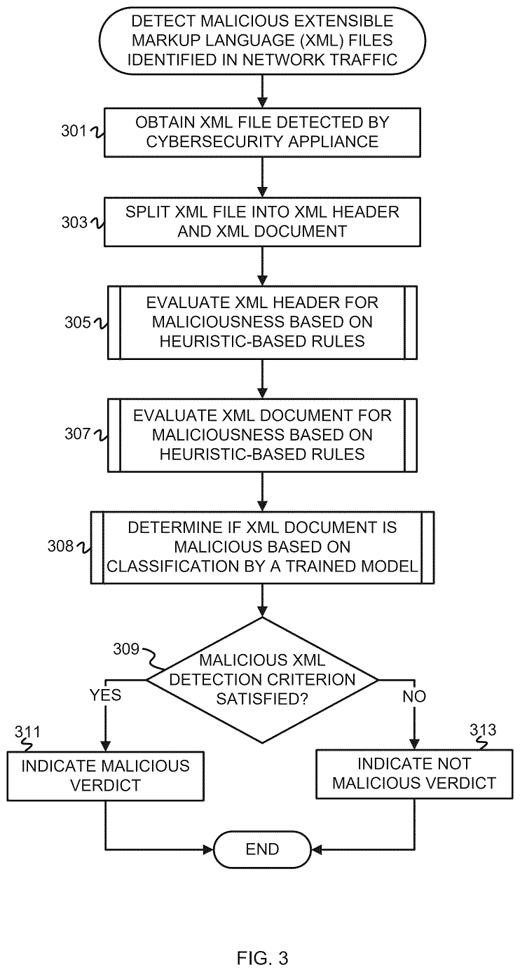

FIGS. 3-6 are flowcharts of example operations. The example operations are described with reference to a traffic filter and a malicious XML detector (hereinafter “the detector”) for consistency with the earlier Figures and/or ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 3 is a flowchart of example operations for inline detection of malicious XML files identified in network traffic. The example operations assume that a cybersecurity appliance (e.g., a firewall) has been deployed to secure a network. Additionally, while depicted as sequential operations in FIG. 3, the example operations depicted at blocks 305, 307, and 308 can be performed in parallel.

At block 301, the detector obtains an XML file detected by the cybersecurity appliance. The XML file was detected by the cybersecurity appliance in inbound or outbound network traffic and designated for further analysis for the presence of malicious XML based on satisfying a rule for detecting XML files in network traffic, such as a pattern for XML files to which a network traffic payload matched. Subsequent operations assume that the XML file comprises an XML header and an XML document.

At block 303, the detector splits the XML file into the XML header and XML document. The detector splits the XML file into its header and the XML document, or the contents of the XML file following the header.

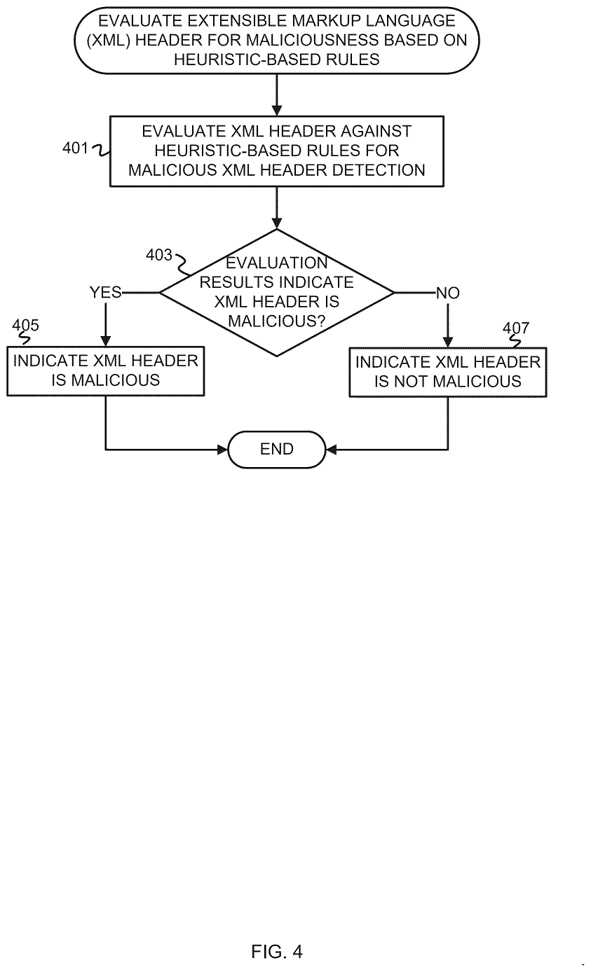

At block 305, the detector evaluates the XML header for maliciousness based on heuristic-based rules. The heuristics-based rules may include patterns for detecting unusual characters or header schemas and/or patterns for detecting certain attacks carried out at least partly or detectable via XML headers. Evaluation of an XML header for maliciousness is described in further detail in reference to FIG. 4.

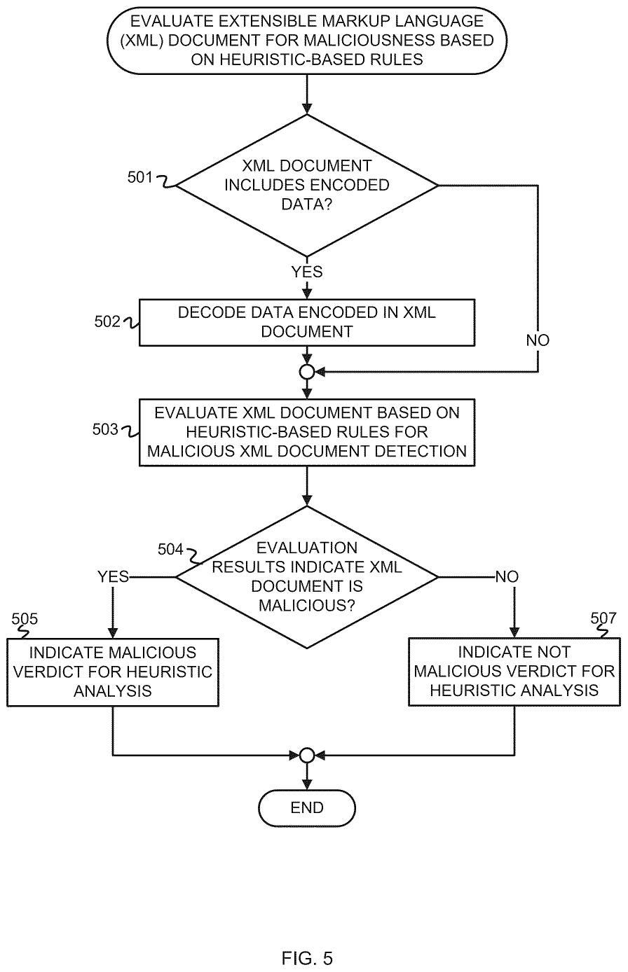

At block 307, the detector evaluates the XML document for maliciousness based on heuristic-based rules. The detector evaluates the XML document based on heuristics-based rules for detecting malicious XML documents, such as based on one or more patterns for identifying embedded code in an XML document. Heuristic evaluation of an XML document for maliciousness is described in further detail in reference to FIG. 5.

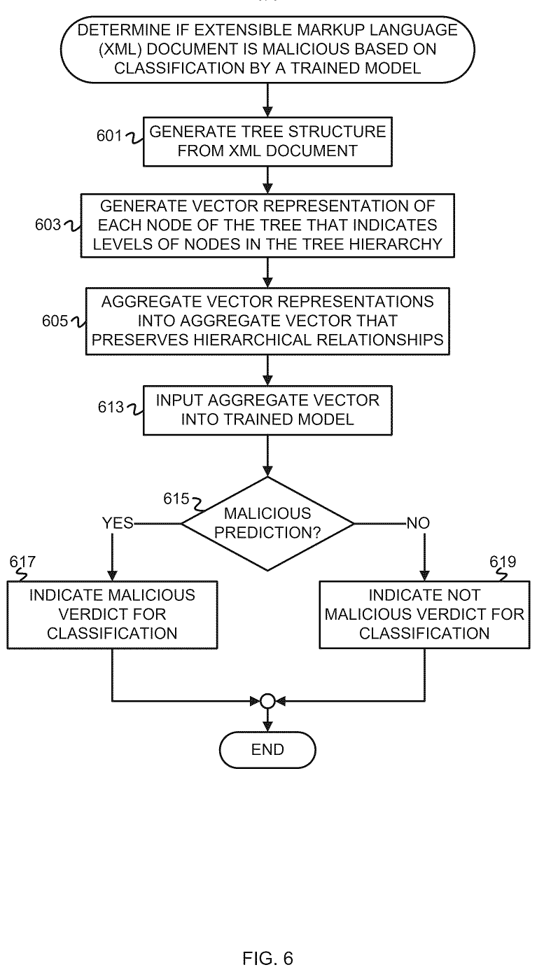

At block 308, the detector determines if the XML document is malicious based on classification by a trained model. The detector generates an embedding representation of the XML document and supplies the embedding for classification by a trained model (e.g., a trained neural network). Determining whether an XML document is malicious based on classification by a trained model is described in further detail in reference to FIG. 6.

At block 309, the detector determines if a malicious XML detection criterion is satisfied. The detection criterion can be a criterion that the XML file should be determined to be malicious if at least one of its header and its document portion was determined to be malicious. Whether the document portion is determined to be malicious can be based on whether the heuristic analysis and/or the classification by the trained model yielded a malicious verdict. If the detection criterion is satisfied, operations continue at block 311. If the detection criterion is not satisfied, operations continue at block 313.

At block 311, the detector indicates a malicious verdict. The detector can indicate (e.g., communicate) to the cybersecurity appliance that the XML file is malicious, and the XML file can thus be blocked from transmission.

At block 313, the detector indicates a not malicious verdict. The detector can indicate to the cybersecurity appliance that the XML file is not malicious and can be forwarded over the network to its destination, provided that the corresponding network traffic is permitted to pass through the cybersecurity appliance based on a security policy with which it is configured.

FIG. 4 is a flowchart of example operations for evaluating an XML header for maliciousness based on heuristic-based rules. At block 401, the detector evaluates the XML header against heuristic-based rules for malicious XML header detection. The heuristic-based rules comprise a plurality of rules for heuristically determining if an XML header is likely to be malicious. Each rule can indicate a threshold, criterion, etc. that, if satisfied, is indicative of maliciousness of the XML header. Examples of heuristic-based rules include rules for checking whether the header schema, length, and/or characters are indicative of maliciousness. As an example, a header with a length exceeding a threshold and that includes special characters not typically included in XML headers may satisfy one or more of the rules and thus is more likely to be malicious than an XML header with a length below the threshold that does not include any special characters. The heuristic-based rules can also include one or more patterns for detecting attacks or exploits of certain vulnerabilities, such as patterns for detecting SSRF attacks, DoS attacks, XPath injection, and/or namespace confusion attacks. These patterns can be regular expressions to which XML headers indicative of a corresponding one of the attacks/exploits should match and may have been defined based on expert/domain knowledge.

At block 403, the detector determines if the evaluation results indicate that the XML header is malicious. The detector may determine that the XML header is malicious if one of the heuristic-based rules is satisfied, a certain number or combination of heuristic-based rules is satisfied, etc. If so, operations continue at block 405, where detector indicates that the XML header is malicious (e.g., by generating a notification, alert, report, etc., which may include an indication of the rule(s) that was satisfied and contributed to the malicious verdict). If no rules are satisfied, operations continue at block 407, where the detector indicates that the XML header is not malicious.

FIG. 5 is a flowchart of example operations for evaluating an XML document for maliciousness based on heuristics-based rules. At block 501, the detector determines if the XML document includes encoded data. Some XML documents include encoded data that should be decoded before the XML document is evaluated based on the heuristics-based rules. The detector can be configured with one or more patterns for detecting encoded data based on the XML document including a match to the pattern(s). For instance, the detector can detect Base64 encoded data with a pattern that triggers a match for strings with lengths that are a multiple of four, that include only alphanumeric characters (i.e., A-Z, a-z and 0-9) and certain special characters (e.g., “+”, “/” in standard Base64 or “−”, “_” in URL-safe Base64), and that may optionally end with one or two “=” padding characters. Another example pattern with which the detector is configured can be used for detecting URL encoding, where this pattern triggers a match for strings that include characters such as “% XX”, where “XX” are hexadecimal characters (i.e., 0-9, A-F). If the XML document includes encoded data, operations continue at block 502. If not, operations continue at block 503.

At block 502, the detector decodes the data encoded in the XML document. The detector decodes the data in the string that matched the pattern(s) with a decoding technique corresponding to the encoding technique for which the pattern was defined (e.g., with Base64 decoding).

At block 503, the detector evaluates the XML document based on heuristic-based rules for malicious XML document detection. The heuristic-based rules defined for XML document evaluation include patterns for detecting embedded malicious code, and/or other anomalies that are indicative of maliciousness. The presence of encoded data may also be considered in the heuristic evaluation, as the original strings that were encoded in the XML document may include commands for carrying out an attack that will be decoded by the intended recipient of the XML file.

At block 504, the detector determines if the evaluation results indicate that the XML document is malicious. If so, operations continue at block 505. Otherwise, operations continue at block 507.

At block 505, the detector indicates a malicious verdict for the heuristic analysis. The detector can generate a notification, alert, report, etc. indicating that the XML document was determined to be malicious as a result of the heuristic analysis, which may include an indication of the rule(s) that was satisfied and contributed to the malicious verdict.

At block 507, the detector indicates a not malicious verdict for the heuristic analysis. The detector can generate a notification, alert, report, etc. indicating that the XML document was determined not to be malicious as a result of the heuristic analysis.

FIG. 6 is a flowchart of example operations for determining if an XML document is malicious based on classification by a trained model. At block 601, the detector generates a tree structure from the XML document. The detector parses the XML document to generate a tree structure representative thereof, or the XML tree corresponding to the XML document. Each node of the XML tree corresponds to an element represented with XML tags, an attribute, or text of the XML document. The detector can use an open-source and/or off-the-shelf tool for generating XML trees representing XML documents.

At block 603, the detector generates a vector representation of each node of the tree that indicates the levels of the nodes in the tree hierarchy. The detector can use an off-the-shelf/open-source embedding model or a combination of embedding models to generate the vector representation of each node, such as a word2vec or doc2vec model, a one-hot encoding, etc. Generation of the vector representation of each node may be dependent on whether the node represents an element, attribute, or text. To illustrate, the detector can generate a text embedding for nodes representing text with word2vec/doc2vec and can generate a one-hot encoding for nodes representing elements and attributes. The one-hot encoding generated for a node can indicate a value of one for elements representing each tag name or attribute name identified in the node and a value of zero for all other elements/attributes not identified in the node.

As part of generating a vector representation of each node of the tree, the detector also can indicate a level of the hierarchy in the tree structure for each node's vector. The level in the hierarchy may be represented numerically, such as by starting at zero for the root node of the XML tree, with the hierarchical level of each other node corresponding to its depth in the XML tree. The detector appends an indication of the hierarchical level of each node to its corresponding vector representation, such as with another vector representing the level in the hierarchy, a raw numerical value indicating the level of the node in the hierarchy, etc.

At block 605, the detector aggregates the vector representations into an aggregate vector that preserves the hierarchical relationships. The aggregation technique can be dependent on the trained model being used for malicious XML detection. For instance, in implementations that use a trained Tree-LSTM model, the detector can aggregate the vector representations to maintain the underlying tree structure of the XML tree, where the aggregate vector comprises the hierarchically-arranged vectors representing the nodes of the XML tree. In other examples, the hierarchical level indications will have been associated with each vector at the time of vector generation at block 509, so the detector can concatenate the vectors to generate the aggregate vector, where the concatenation of vectors may be in the same order of which the XML tree was processed to generate the vector representations of its nodes. In this case, the hierarchical structure of the XML tree is preserved due to the indications of hierarchical levels being included with each vector representation generated for a respective node of the XML tree.

At block 613, the detector inputs the aggregate vector into a trained model. The trained model has been trained on examples of malicious and non-malicious XML documents for which corresponding aggregate vectors were generated as similarly described above. The trained model can be a trained LSTM model, a trained Tree-LSTM model, or another neural network (e.g., other recurrent neural networks (RNNs) architectures) trained to classify XML documents based on their vector representations.

At block 615, the detector determines if the XML document was predicted to be malicious based on output of the trained model. The detector obtains an output of the trained model indicating the predicted class of the XML document (i.e., malicious or not malicious). The output may further indicate a probability associated with the prediction. Whether the XML document is malicious can be dependent on the predicted class and optionally whether the associated probability of the predicted class satisfies a threshold such that the prediction is sufficiently confident. If the XML document was predicted to be malicious, operations continue at block 617. If not, operations continue at block 619.

At block 617, the detector indicates a malicious verdict for the XML document for classification. The detector can generate a notification, alert, report, etc. indicating that the XML document was classified as malicious using the trained model.

At block 619, the detector indicates a not malicious verdict for the XML document for classification. The detector can generate a notification, alert, report, etc. indicating that the XML document was classified as not malicious using the trained model.

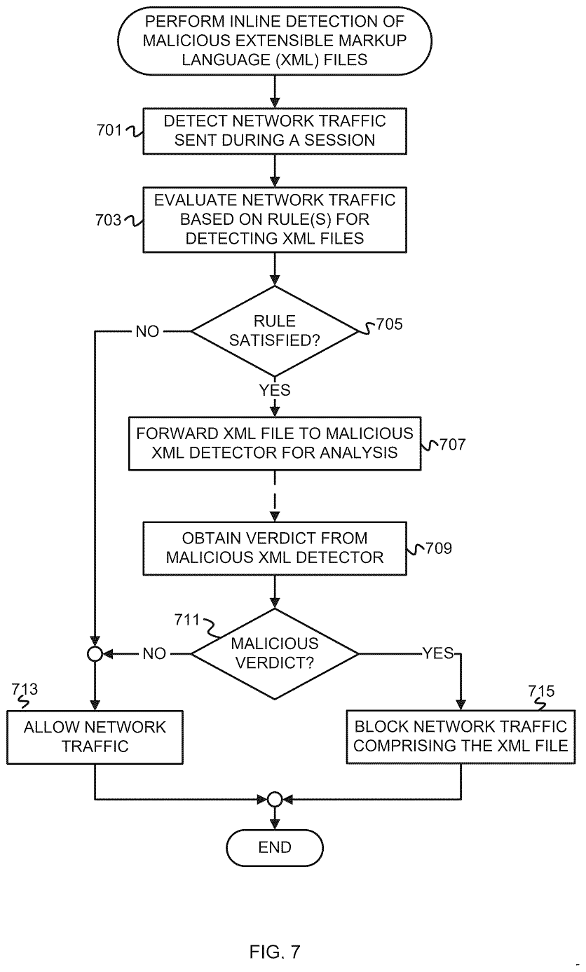

FIG. 7 is a flowchart of example operations for performing inline detection of malicious XML files. The example operations are described as being performed by the traffic filter, which executes as part of a cybersecurity appliance (e.g., a firewall).

At block 701, the traffic filter detects network traffic sent during a session. The network traffic may be inbound or outbound network traffic.

At block 703, the traffic filter evaluates the network traffic based on one or more rules for detecting XML files. The rule(s) may comprise a pattern for detecting XML files in network traffic (e.g., in HTTP requests/responses), such as a pattern for detecting “<? xml” that corresponds to an XML header.

At block 705, the traffic filter determines if a rule for detecting XML files in network traffic was satisfied. If a rule was satisfied, operations continue at block 707. Otherwise, operations continue at block 713.

At block 707, the traffic filter forwards the XML file to the malicious XML detector for analysis. The traffic filter can forward the network traffic payload(s) in which the XML file was detected to the malicious XML detector or can extract (e.g., copy) the XML file therefrom and forward the extracted XML file to the malicious XML detector. The malicious XML detector analyzes the XML file as described above to determine if the XML file is malicious. The transition from block 707 to block 709 is depicted with a dashed line to indicate that the traffic filter awaits a verdict from the malicious XML detector before proceeding.

At block 709, the traffic filter obtains a verdict from the malicious XML detector. The verdict indicates whether the XML file is predicted to be malicious or not.

At block 711, the traffic filter determines if the verdict indicates that the XML file is malicious. If the verdict indicates that the XML file is not malicious, operations continue at block 713. If the verdict indicates that the XML file is malicious, operations continue at block 715.

At block 713, the traffic filter allows the network traffic. The network traffic may be the network traffic that was initially detected and determined not to include an XML file (if operations proceeded to block 713 from block 705) or the network traffic that comprised the XML file determined not to be malicious (if operations proceeded to block 713 from block 711). Allowing the network traffic to proceed may be further subject to the network traffic being permitted to pass in accordance with a security policy with which the cybersecurity appliance is configured; in other words, the cybersecurity appliance may perform additional analysis of the network traffic before the network traffic is permitted to pass.

At block 715, the traffic filter blocks the network traffic comprising the XML file. The traffic filter blocks the malicious XML file from being permitted to pass. The traffic filter can further quarantine the XML file for additional inspection.

### Variations

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For instance, with reference to FIG. 3, the operations performed at blocks 305, 307, and 308 can be performed at least partially in parallel. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example but not limited to, a system, apparatus, or device, that employs one or a combination of electronic, magnetic, optical, electromagnetic, infrared, or semiconductor technology to store program code. More specific examples (a non-exhaustive list) of the machine-readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions which implement the function/act specified in the flowchart and/or block diagram block or blocks.

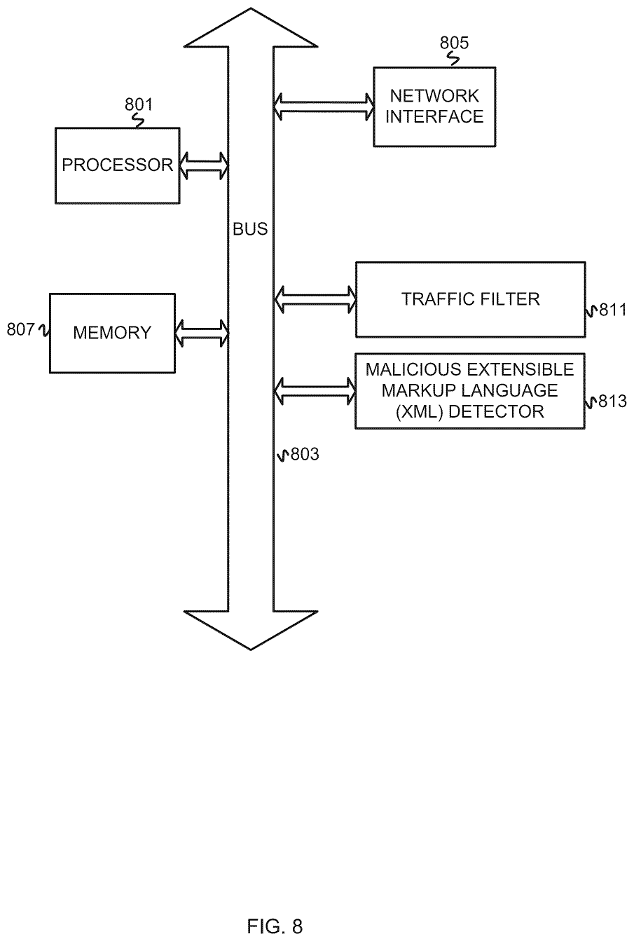

FIG. 8 depicts an example computer system with a traffic filter and a malicious XML detector. The computer system includes a processor 801 (possibly including multiple processors, multiple cores, multiple nodes, and/or implementing multi-threading, etc.). The computer system includes memory 807. The memory 807 may be system memory or any one or more of the above already described possible realizations of machine-readable media. The computer system also includes a bus 803 and a network interface 805. The system also includes traffic filter 811 and malicious XML detector 813. The traffic filter 811 filters for network traffic or data extracted therefrom that should be forwarded to a corresponding service for further security analysis based on sets of rules with which the traffic filter 811 has been configured, such as rules for detecting XML files transmitted in network traffic. The malicious XML detector 813 analyzes detected XML files for maliciousness using heuristic and deep learning techniques. While depicted as part of the same computer system in FIG. 8 to aid in understanding, the traffic filter 811 and malicious XML detector 813 do not necessarily execute as part of the same system. For instance, the traffic filter 811 can execute as a cybersecurity appliance, while the malicious XML detector 813 can execute as a cloud-based service with which the cybersecurity appliance communicates. Any one of the previously described functionalities may be partially (or entirely) implemented in hardware and/or on the processor 801. For example, the functionality may be implemented with an application specific integrated circuit, in logic implemented in the processor 801, in a co-processor on a peripheral device or card, etc. Further, realizations may include fewer or additional components not illustrated in FIG. 8 (e.g., video cards, audio cards, additional network interfaces, peripheral devices, etc.). The processor 801 and the network interface 805 are coupled to the bus 803. Although illustrated as being coupled to the bus 803, the memory 807 may be coupled to the processor 801.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
based on detection of an extensible markup language (XML) file, analyzing the XML file based on a plurality of heuristics-based rules for determining if XML files are malicious, wherein the XML file comprises an XML document;
generating a vector representation of the XML document and inputting the vector representation of the XML document into a trained neural network, wherein the trained neural network was trained to classify XML documents as malicious or not malicious; and
generating a verdict indicating if the XML file is malicious based on at least one of a result of analyzing the XML file based on the plurality of heuristics-based rules and a classification of the XML document predicted by the trained neural network.

2. The method of claim 1, wherein the XML file also comprises an XML header, and wherein analyzing the XML file based on the plurality of heuristics-based rules comprises analyzing the XML header based on a first subset of the plurality of heuristics-based rules.

3. The method of claim 2, wherein analyzing the XML file based on the plurality of heuristics-based rules comprises analyzing the XML document based on a second subset of the plurality of heuristics-based rules.

4. The method of claim 3, wherein determining that the result of analyzing the XML file based on the plurality of heuristics-based rules indicates that the XML file is not malicious comprises determining that the result of analyzing the XML header indicates that the XML header is not malicious and determining that a result of analyzing the XML document indicates that the XML document is not malicious.

5. The method of claim 1, wherein the trained neural network comprises a trained long short-term memory (LSTM) model.

6. The method of claim 5, wherein the trained LSTM model comprises a trained Tree-LSTM model.

7. The method of claim 1, wherein generating the vector representation of the XML document comprises,
generating an XML tree corresponding to the XML document, wherein the XML tree comprises a plurality of nodes;
generating a plurality of vectors representing the plurality of nodes; and
aggregating the plurality of vectors to generate an aggregate vector representation of the XML document, wherein inputting the vector representation of the XML document into the trained neural network comprises inputting the aggregate vector representation into the trained neural network, wherein the aggregate vector representation preserves hierarchical relationships among the plurality of nodes in the XML tree.

8. The method of claim 7, wherein generating the plurality of vectors representing the plurality of nodes comprises, for each node of the plurality of nodes, generating a word vector, a document vector, or a one-hot vector representing the node.

9. The method of claim 8, wherein generating a word vector, a document vector, or a one-hot vector representing the node comprises,
based on determining that the node corresponds to text, generating a word vector or document vector representing the node; and
based on determining that the node corresponds to an element or attribute, generating a one-hot vector representing the node.

10. The method of claim 1, wherein the XML file was detected by a cybersecurity appliance, wherein the method further comprises indicating the verdict that indicates if the XML file is malicious to the cybersecurity appliance.

11. One or more non-transitory machine-readable media having program code stored thereon, the program code comprising instructions to:
based on detection of an extensible markup language (XML) file, determine whether the XML file is malicious based on heuristic analysis of at least one of an XML header and an XML document of the XML file;
generate an embedding of the XML document; and
input the embedding of the XML document into a trained model that was trained to classify XML documents as malicious or not malicious; and
indicate whether the XML document is malicious based on at least one of a result of the heuristic analysis of the XML file and a prediction output by the trained model of whether the XML document is malicious.

12. The non-transitory machine-readable media of claim 11, wherein the instructions to determine whether the XML file is malicious based on heuristic analysis of at least one of the XML header and the XML document comprise at least one of instructions to analyze the XML header based on a first set of heuristics-based rules and instructions to analyze the XML document based on a second set of heuristics-based rules.

13. The non-transitory machine-readable media of claim 11, wherein the instructions to generate the embedding of the XML document comprise instructions to,
generate an XML tree representing the XML document; and
for each node of a plurality of nodes of the XML tree, generate an embedding representing the node, wherein the embedding of the XML document comprises a plurality of embeddings generated from the plurality of nodes.

14. The non-transitory machine-readable media of claim 11, wherein the trained model comprises a trained long short-term memory (LSTM) model or a trained Tree-LSTM model, wherein the instructions to input the embedding of the XML document into the trained model comprise instructions to input the embedding into the trained LSTM model or the trained Tree-LSTM model.

15. An apparatus comprising:
a processor; and
a machine-readable medium having instructions stored thereon that are executable by the processor to cause the apparatus to,
based on detection of an extensible markup language (XML) file, analyze at least one of an XML header and an XML document of the XML file based on a plurality of heuristics-based rules for determining if XML files are malicious;
generate a vector representation of the XML document and input the vector representation of the XML document into a trained neural network, wherein the trained neural network was trained to predict whether XML documents are malicious; and
generate a verdict indicating if the XML file is malicious based on at least one of a result of analysis of the XML file based on the plurality of heuristics-based rules and a prediction of whether the XML document is malicious output by the trained neural network.

16. The apparatus of claim 15, wherein the instructions executable by the processor to cause the apparatus to analyze the at least one of the XML header and the XML document comprise instructions executable by the processor to cause the apparatus to,
analyze the XML header based on a first subset of the plurality of heuristics-based rules; and
analyze the XML document based on a second subset of the plurality of heuristics-based rules.

17. The apparatus of claim 15, wherein the trained neural network comprises a trained long short-term memory (LSTM) model or a trained Tree-LSTM model, and wherein the instructions executable by the processor to cause the apparatus to input the vector representation of the XML document into the trained neural network comprise instructions executable by the processor to cause the apparatus to input the vector representation of the XML document into the trained LSTM model or the trained Tree-LSTM model.

18. The apparatus of claim 15, wherein the instructions executable by the processor to cause the apparatus to generate the vector representation of the XML document comprise instructions executable by the processor to cause the apparatus to,
generate an XML tree corresponding to the XML document, wherein the XML tree comprises a plurality of nodes;
generate a vector representation of each of the plurality of nodes; and
generate the vector representation of the XML document from vector representations of the plurality of nodes, wherein the vector representation of the XML document preserves a hierarchical structure of the plurality of nodes.

19. The apparatus of claim 18, wherein the instructions executable by the processor to cause the apparatus to generate the vector representation of each of the plurality of nodes comprise instructions executable by the processor to cause the apparatus to generate at least one of a word vector, a document vector, and a one-hot vector of each of the plurality of nodes.

20. The apparatus of claim 15, further comprising instructions executable by the processor to cause the apparatus to indicate the verdict to a cybersecurity appliance, wherein the cybersecurity appliance detected the XML file.
